(19) United States
(12) Patent Application Publication
(10) Pub. No.: US 2026/0095422 A1
(43) Pub. Date: Apr. 2, 2026

(54) SESSION INTERACTION

(71) Applicant: Beijing Zitiao Network Technology Co., Ltd., Haidian District, Beijing (CN)

(72) Inventors: Ran Zhang, Beijing (CN); Ziyang Zheng, Beijing (CN); Song Luo, Beijing (CN); Daoyu Wang, Beijing (CN)

(21) Appl. No.: 19/101,866

(22) PCT Filed: Jul. 31, 2024
(86) PCT No.: PCT/CN2024/108904

§ 371 Date: Feb. 6, 2025

(51) Int. Cl. H04L 51/02; G06F 3/04842

(52) U.S. Cl. CPC H04L 51/02; G06F 3/04842

(57) ABSTRACT

According to an embodiment of the disclosure, a method, apparatus, device, and storage medium for session interaction is provided. The method includes receiving a selection of one or more target digital assistants in a target session by a user, the one or more target digital assistants being not members of the target session, and members of the target session comprising a plurality of digital assistants; presenting a first message sent by the user in the target session; and presenting one or more reply messages for the first message sent by the one or more target digital assistants, respectively. Therefore, the user can select a digital assistant that does not belong to the session to reply to the message sent by the user, thereby improving convenience of interaction between the user and the digital assistant.

### FIELD

Example embodiments of the present disclosure generally relate to the field of computers, and in particular, to methods, apparatuses, devices, and computer-readable storage media for session interaction.

### BACKGROUND

With the development of information technologies, various terminal devices may provide various services to people in terms of work and life. An application providing a service may be deployed in the terminal device. The terminal device or application may provide a digital assistant function to the user to assist the user in using the terminal device or application. How to improve the flexibility of interaction between a user and a digital assistant is a technical problem to be explored currently.

### SUMMARY

In a first aspect of the present disclosure, a method of session interaction is provided. The method comprises receiving a selection of one or more target digital assistants in a target session by a user, the one or more target digital assistants being not members of the target session, and members of the target session comprising a plurality of digital assistants; presenting a first message sent by the user in the target session; and presenting one or more reply messages for the first message sent by the one or more target digital assistants, respectively.

In a second aspect of the present disclosure, an apparatus for session interaction is provided. The apparatus comprises a selection receiving module configured to receive a selection of one or more target digital assistants by a user in a target session, the one or more target digital assistants being not members of the target session, and members of the target session comprise a plurality of digital assistants; a message presenting module configured to present a first message sent by the user in the target session; and a reply message presenting module configured to present one or more reply messages for the first message sent by the one or more target digital assistants, respectively.

In a third aspect of the present disclosure, an electronic device is provided. The device comprises at least one processing unit; and at least one memory, the at least one memory coupled to the at least one processing unit and storing instructions for execution by the at least one processing unit, the instructions upon execution by the at least one processing unit, causing the electronic device to perform the method of the first aspect.

In a fourth aspect of the present disclosure, a computer-readable storage medium is provided. The computer-readable storage medium thereon stores a computer program, the computer program being executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood by the following description.

### BRIEF DESCRIPTION OF DRAWINGS

Through the following detailed description with reference to the accompanying drawings, the above and other features, and advantages and aspects of example embodiments of the present disclosure will become more apparent. In the drawings, the same or similar reference numerals refer to the same or similar elements, wherein:

FIG. 1 illustrates a schematic diagram of an example environment in which embodiments of the present disclosure can be implemented;

FIG. 2A to FIG. 2F illustrate schematic diagrams of example interfaces for session interaction according to some embodiments of the present disclosure;

FIG. 3A to FIG. 3E illustrate schematic diagrams of example interfaces for session interaction according to some other embodiments of the present disclosure;

FIG. 4A to FIG. 4C illustrate schematic diagrams of example interfaces for session interaction according to yet other embodiments of the present disclosure;

FIGS. 5A-FIG. 5C illustrate schematic diagrams of example interfaces for adding a digital assistant according to some embodiments of the present disclosure;

FIG. 6A to FIG. 6F are schematic diagrams of example interfaces for session interaction according to some embodiments of the present disclosure;

FIG. 7 illustrates a flowchart of a process of session interaction process according to some embodiments of the present disclosure;

FIG. 8 illustrates a block diagram of an apparatus for session interaction according to some embodiments of the present disclosure; and

FIG. 9 illustrates a block diagram of a device capable of implementing various embodiments of the present disclosure.

### DETAILED DESCRIPTION

It can be understood that, before the technical solutions disclosed in the embodiments of the present disclosure are used, the types, the usage scope, the usage scenario and the like of personal information related to the present disclosure, should be notified to the user in an appropriate manner and obtain the authorization of the user, according to the relevant laws and regulations.

For example, in response to receiving an active request from a user, prompt information is sent to the user to explicitly prompt the user that the requested operation to be performed will need to obtain and use the personal information of the user. Therefore, the user is enabled to autonomously select whether to provide personal information to software or hardware such as applications, servers or storage medium, executing the operation of the technical solution of the present disclosure, according to the prompt information.

As an optional but non-limiting implementation, in response to receiving the active request of the user, the manner of sending the prompt information to the user may be, for example, a pop-up window, and the pop-up window may present the prompt information in a text manner. In addition, the pop-up window may further carry a selection control for the user to select “agree” or “not agree”to provide personal information to the electronic device.

It may be understood that the above notification and obtaining user's authorization process is merely illustrative, and does not constitute a limitation on implementations of the present disclosure, and other manners of meeting related laws and regulations may also be applied to implementations of the present disclosure.

It may be understood that the data involved in the technical solution (including but not limited to the data itself, the obtaining or use of the data) should follow the requirements of the corresponding laws and regulations and related regulations.

Embodiments of the present disclosure will be described in more detail below with reference to the accompanying drawings. Although some embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

Herein, unless explicitly stated, “in response to A” performs one step and does not imply that this step is performed immediately after “A”, but may include one or more intermediate steps.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

As mentioned briefly above, the collaboration of people and language model robots is increasing and people expand their capability boundaries by means of dialoguing with a digital assistant. Currently, a user may interact with a digital assistant in a session (e.g., a single chat) between a user and a single digital assistant. The user may also interact with the digital assistant in a session (e.g., group chat) of between a user anda plurality of digital assistants. However, in the above manner, the digital assistant is required to belong to a member in the session. Accordingly, in the session between the user and the digital assistant, for the message from the user, is replied by the matching digital assistant determined by the system according to the user's intent.

In view of this, embodiments of the present disclosure provide an improved solution for session interaction. According to various embodiments of the present disclosure, receiving a selection of one or more target digital assistants in a target session by a user, the one or more target digital assistants being not members of the target session, and members of the target session comprising a plurality of digital assistants; presenting a first message sent by the user in the target session; and presenting one or more reply messages for the first message sent by the one or more target digital assistants, respectively. Therefore, the user may select a digital assistant that does not belong to the session to reply to the message sent by the user, thereby improving convenience of interaction between the user and the digital assistant.

### Example Environment

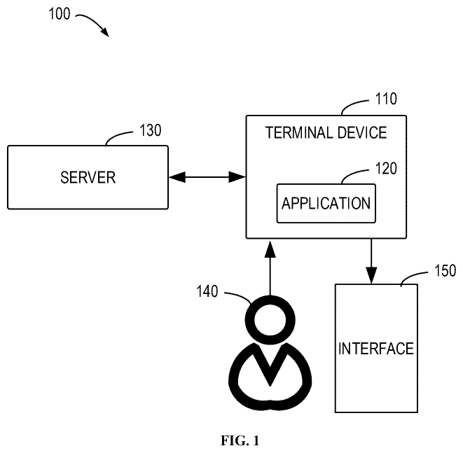

FIG. 1 illustrates a schematic diagram of an example environment 100 in which embodiments of the present disclosure can be implemented. In this example environment 100, an application 120 is installed in the terminal device 110. The user 140 may interact with the application 120 via the terminal device 110 and/or an attachment device of the terminal device 110.

In some embodiments, the application 120 may be any suitable application that may provide query services. In environment 100 of FIG. 1, terminal device 110 may present page 150 of application 120 if application 120 is active. The page 150 may include various pages that can be provided by the application 120, such as a session interaction page, a query page, a search page, a search result presentation page, and the like.

In some embodiments, terminal device 110 communicates with server 130 to enable provisioning of services to application 120. The terminal device 110 may be any type of mobile terminal, a fixed terminal, or a portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio streaming receiver, an electronic book device, a game device, or any combination thereof, including accessories and peripherals of these devices, or any combination thereof. In some embodiments, the terminal device 110 may also support any type of interface for a user (such as a “wearable” circuit, etc.) . The server 130 may be various types of computing systems/servers capable of providing computing power, including, but not limited to, mainframes, edge computing nodes, computing devices in a cloud environment, and the like.

It should be understood that the structures and functions of the various elements in the environment 100 are described for exemplary purposes only and do not imply any limitation to the scope of the present disclosure.

Some example embodiments of the present disclosure will continue to be described below with reference to the accompanying drawings. It should be understood that the pages shown in the drawings are merely examples, and various page designs may actually exist. Individual graphical elements in a page may have different arrangements and different visual representations, one or more of which may be omitted or replaced, and one or more other elements may also be present. Embodiments of the present disclosure are not limited in this respect. In addition, in the following, example embodiments will be described primarily with respect to the terminal device 110. It should be understood that the actions described with respect to the terminal device 110 may be performed by the application 120 on the terminal device 110, or may be performed by the application 120 in cooperation with the server (for example, the server 130).

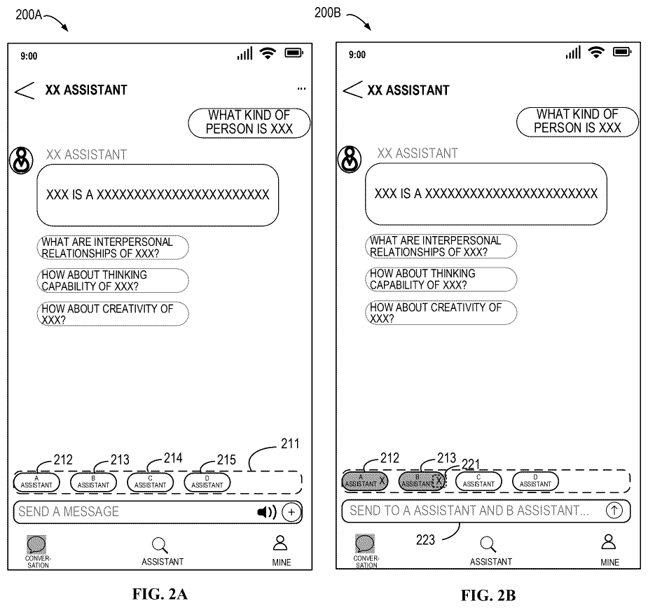

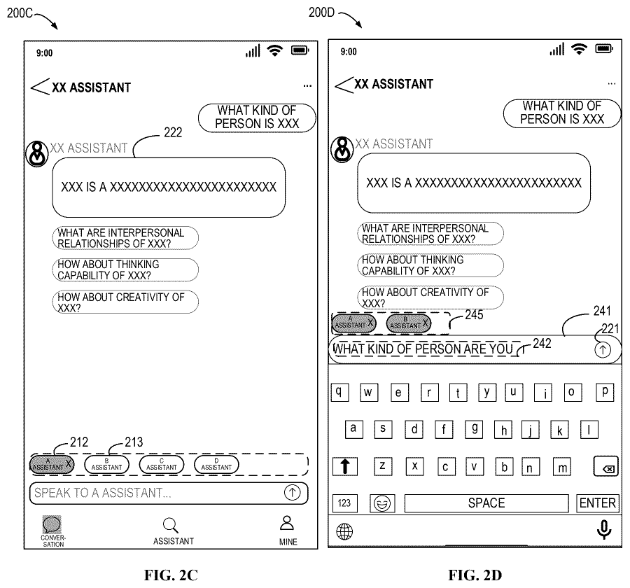

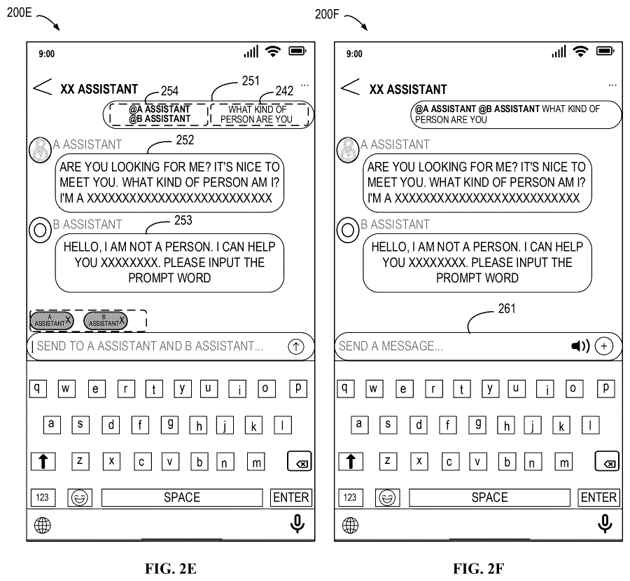

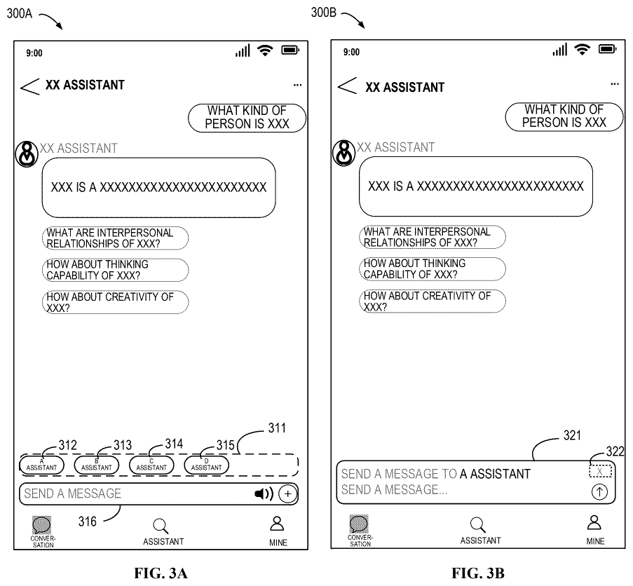

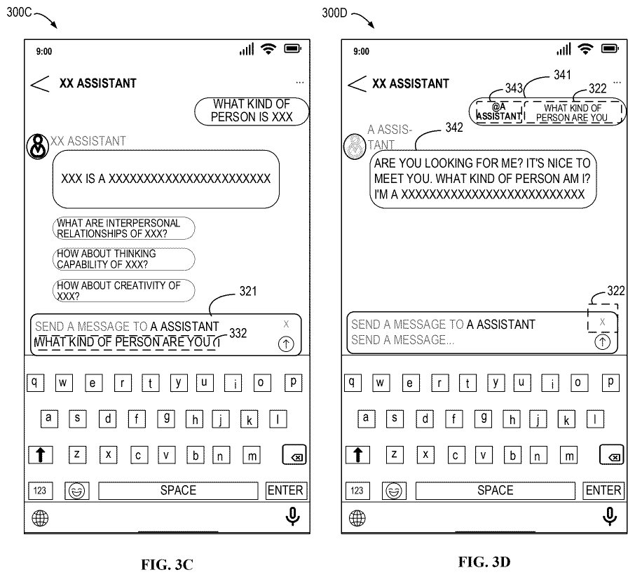

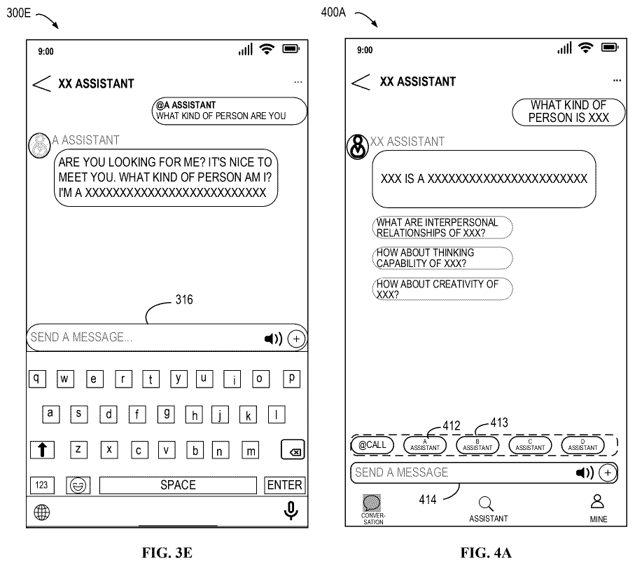

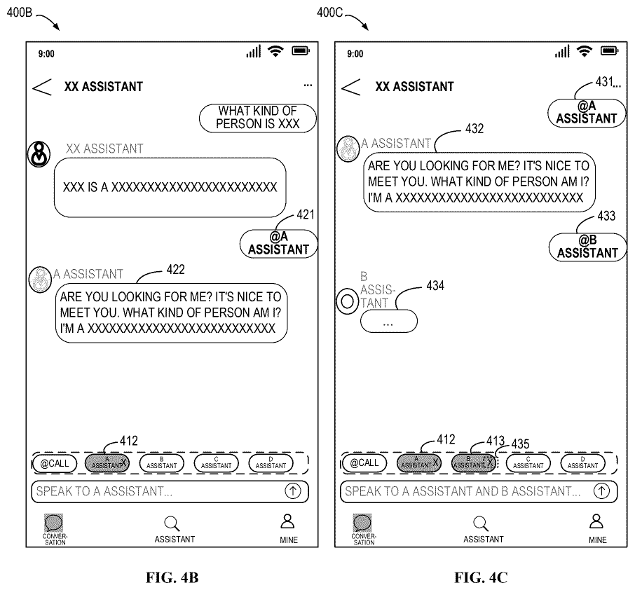

The process for session interaction of the present disclosure is described below with reference to three examples of FIG. 2A to FIG. 2F, FIG. 3A to FIG. 3E, and FIG. 4A to FIG. 4C. FIG. 2A to FIG. 2F illustrate schematic diagrams of example interfaces 200A-200F for session interaction, according to some embodiments of the present disclosure. FIG. 3A to FIG. 3E illustrate schematic diagrams of example interfaces 300A-300E for session interaction according to other embodiments of the present disclosure. FIG. 4A to FIG. 4C illustrate schematic diagrams of example interfaces 400A-400C for session interaction according to yet other embodiments of the present disclosure.

In some embodiments, the terminal device 110 receives a selection of one or more target digital assistants in a target session by a user. In some embodiments, the one or more digital assistants do not belong to a member of the target session that includes a plurality of digital assistants. In some examples, user 140 may reply to the message sent by user 140 in a target session (e.g., session of user 140 with a preset digital assistant) selecting one or more digital assistants that do not belong to the target session member.

In some embodiments, the terminal device 110 may receive a selection of one or more target digital assistants in a target session by a user in the following manner. The terminal device 110 presents a selection control for the at least one digital assistant in an interface of the target session. The terminal device 110 then receives a trigger operation for a respective selection control of one or more target digital assistants of the at least one digital assistant.

As shown in the example interface 200A shown in FIG. 2A, the terminal device 110 presents the selection control 212 for the A assistant, the selection control 213 for the B assistant, the selection control 214 for the C assistant, the selection control 215 for the D assistant, and the like in the interface of the target session. In some examples, the terminal device 110 may further present, in the operation bar 211 included in the interface of the target session, a selection control 212 for the A assistant, a selection control 213 of the B assistant, a selection control 214 of the C assistant, and the like. For the selection control 212 of the A assistant the selection control 213 of the B assistant, the selection control 214 of the C assistant, the selection control 215 of the D assistant, and the like, presented by the terminal device 110, the user 140 may click the selection control above to select one or more target digital assistants.

In some embodiments, if the terminal device 110 receives the trigger operation on the selection control corresponding to the one or more target digital assistants, the terminal device 110 may present the corresponding selection control of the one or more target digital assistants in a preset style. In some examples, when the terminal device 110 supports the user 140 to select one or more digital assistants, if the user 140 clicks the selection control of the A assistant and the selection control of the B digital assistant, the A assistant and the B assistant are in the selected state, and at this time, the sending button is activated. As shown in the example interfaces 200A to 200B shown in FIG. 2A to FIG. 2B, if the terminal device 110 receives clicks by the user 140 on the selection control 212 of the A assistant and the selection control 213 of the B assistant, the selection control 212 of the A assistant and the selection control 213 of the B assistant are highlighted. For example, the selection control 212 and the selection control 213 are populated in different colors or patterns.

In some other examples, when the terminal device 110 supports the user 140 to select one digital assistant, if the user 140 clicks the selection control of the A assistant, the assistant A is in the selected state, and at this time, the sending button of the input box 321 is activated. As shown in the example interfaces 300A to 300B shown in FIG. 3A to FIG. 3B, if the terminal device 110 receives a click by the user 140 on the selection control 312 of the A assistant, the selection control 312 of the A assistant may be presented in the input box 321.

In some embodiments, the user 140 may cancel the selected target digital assistant at any time, and the cancelled target digital assistant will no longer reply to the message of the user 140. As shown in the example interfaces 200B-200C shown in FIG. 2Bto FIG. 2C, the user 140 cancels the selection of the B assistant if a close control 221 is clicked on the B assistant. As shown in the example interface 300B of FIG. 3B, if the user 140 clicks the close control 322 on the A assistant, the selection of assistant A is canceled.

In some embodiments, when the user 140 selects one or more target digital assistants, if the user clicks the input box, the terminal device 110 only presents the identification information of the one or more target digital assistants in an area above the input box. As shown in the example interface 200D shown in FIG. 2D, when the user 140 selects the A assistant and the B assistant, if the user 140 clicks the input box 241, the terminal device 110 presents the identification information of the A assistant and the B assistant in the area 245 above the input box 241.

In some embodiments, after selecting the one or more target digital assistants by the user 140, the terminal device 110 may display prompt information in an input box included in an interface of the target session. For example, the terminal device 110 selects a digital assistant for the user 140, and the prompt information that may be displayed may be “speak to XX assistant . . . ”. The terminal device 110 selects two digital assistants for the user 140, and the prompt information that may be displayed may be “speak to XX assistant and XXX assistant”. The terminal device 110 selects a plurality of digital assistants for the user 140, and the prompt information that may be displayed may be “speak to XX assistant, XXX assistant, etc.”. If the user 140 selects a digital assistant with a long name, the prompt information may be displayed by the terminal device 110 may be “speak to XX assistant, XXX . . . ”. As shown in FIG. 2B, if the user 140 selects the A assistant and the B assistant, the terminal device 110 displays “send to A assistant and B assistant” in the input box 223. As shown in FIG. 3B, if the user 140 selects the A assistant, the terminal device 110 displays “send to the A assistant” or “speak to the A assistant” in the input box 321.

In some embodiments, the terminal device 110 presents the first message sent by the user in the target session. In some embodiments, the terminal device 110 may present the first message sent by the user in the target session in the following manner. The terminal device 110 receives user input for one or more target digital assistants. Then, for the sending operation input by the user, the terminal device 110 presents the user input and the mention information of the one or more target number assistants as the first message.

In some examples, after selecting the one or more target digital assistants, the user 140 may input a message in the input box. Then, if the terminal device 110 receives a click by the user 140 on the send button to send the message input by the user, the terminal device 110 presents the mention information (for example, @ XX assistant) for the one or more digital assistants and the message input by the user in the input box in the interface of the target session. In some embodiments, the mention information of the one or more digital assistants presented by the terminal device 110 in the interface of the target session may be mention information that is automatically generated by the terminal device 110 after receiving the click sending button of the user 140. In some embodiments, the terminal device 110 may display the mention information at the forefront of the first message.

As shown in the example interfaces 200D to 200E shown in FIG. 2Dto FIG. 2E, after selecting the A assistant and the B assistant, the user 140 may input a message 242 in the input box. The terminal device 110 then presents the message 251 in the interface of the target session if the terminal device 110 receives a click by the user 140 on the send button 221 to send the message 242 input by the user 140. The message 251 includes the mention information 254 “@ A assistant @ B assistant” automatically generated by the terminal device 110 and the message 242 input by the user 140.

As shown in the example interfaces 300C-300D shown in FIGS. 3C-FIGS. 3D, after selecting the A assistant, the user 140 may input a message 332 in the input box 321. Then, if the terminal device 110 receives a click by the user 140 on the send button to send the message 332 input by the user 140, the terminal device 110 presents the message 341 in the interface of the target session. The message 341 includes the mention information 343 “@ A assistant” automatically generated by the terminal device 110 and the message 322 input by the user 140.

In some embodiments, mention information is presented in a first message in a preset style, and the preset style is associated with the number of one or more target digital assistants. The terminal device 110 may present the mention information for the one or more target digital assistants in a preset style. In some examples, the terminal device 110 may present mention information in a conspicuous style, such as text bolding, plain text bolding. In some examples, if the user 140 selects one digital assistant, the terminal device 110 may present mention information about the digital assistant at the forefront of the first message. If the user 140 selects multiple digital assistants, the terminal device 110 may present multiple mention information about multiple digital assistants, respectively, at the forefront of the first message.

In some embodiments, the terminal device 110 may further present, in another manner, the first message sent by the user in the target session. If the terminal device 110 receives the selection of one or more target digital assistants in the at least one digital assistant by the user, the terminal device 110 presents the first message mentioning the one or more target digital assistants, respectively.

In some examples, after selecting the one or more target digital assistants by the user 140, the terminal device 110 automatically sends a message mentioning the one or more target digital assistants. If a target digital assistant is selected, a mention message is sent. If multiple target digital assistants are selected, multiple mention messages are sent. As shown in the example interfaces 400A to 400C shown in FIG. 4A to FIG. 4C, after the user 140 clicks the selection control 412 of the A assistant to select the A assistant, from the selection control price corresponding to the at least one assistant, the terminal device 110 presents a message 421 in the interface of the target session, and the message 421 includes the mention information “@ A assistant” for the A assistant. After selecting the A assistant and the B assistant by the user 140 by clicking the selection control 412 of the A assistant and the selection control 413 of the B assistant, from the selection control price corresponding to the at least one assistant, the terminal device 110 presents the message 431 and the message 433 in the interface of the target session. Message 431 includes the mention information “@ A assistant” for the A assistant, and message 433 includes the mention information “@ B assistant” for the B assistant. In this way, the response of the digital assistant can be quickly obtained.

In some embodiments, the user 140 clicks the close control of the target digital assistant, and can cancel the selected state of the target digital assistant, but the sent message does not withdraw, and the same target digital assistant is clicked again, and the sending is no longer repeated until the interface of the current session is exited. After exiting and then entering again, the sending is triggered again. As shown in the example interface 400C shown in FIG. 4C, if the user 140 clicks the close control 435 of the B assistant to cancel the selected state of the B assistant, the sent message 433 is not withdrawn, the B assistant is again selected, and the message 433 is no longer repeated until the interface of the current session is exited.

In some embodiments, the terminal device 110 presents one or more reply messages for the first message sent by the one or more digital assistants, respectively. In some examples, the terminal device 110 presents, for the first message sent in the target session, one or more reply messages respectively sent by the one or more target number assistants. As shown in the example interface 200E shown in FIG. 2E, for the message 251, the “@ A assistant @ B assistant what kind of person are you”, the terminal device 110 presents a reply message 252 sent by the A assistant and a reply message 253 sent by the B assistant. As shown in the example interface 300D shown in FIG. 3D, the terminal device 110 presents a reply message 342 sent by the A assistant for the message 341, the “@ A assistant what kind of person are you”.

In some embodiments, for the first message mentioning the one or more target digital assistants, one or more first reply message presented by the terminal device 110 includes the corresponding introduction information for the one or more target digital assistants. It may be understood that, when the first message includes only the mention information of the one or more target digital assistants, the reply message for the first message includes the introduction information of the one or more target digital assistants.

As shown in the example interface 400B shown in FIG. 4B, when the user 140 selects the A assistant, for the message 421 “@ A assistant”, the terminal device 110 presents a reply message 422 that is sent by the A assistant and is used to introduce the A assistant. As shown in the example interface 400C shown in FIG. 4C, when the user 140 selects the A assistant and the B assistant, for the message 431 “@ A assistant”, the terminal device 110 presents a reply message 432 that is sent by the A assistant and is used to introduce the A assistant. Immediately for the message 433 “@ B assistant”, the terminal device 110 presents a reply message 434 sent by the B assistant for introducing the B assistant.

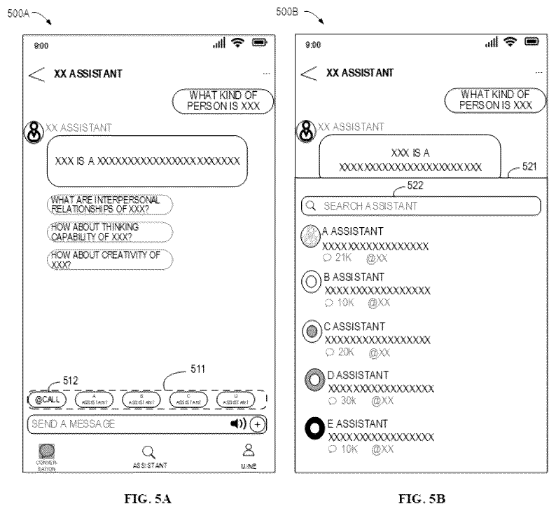

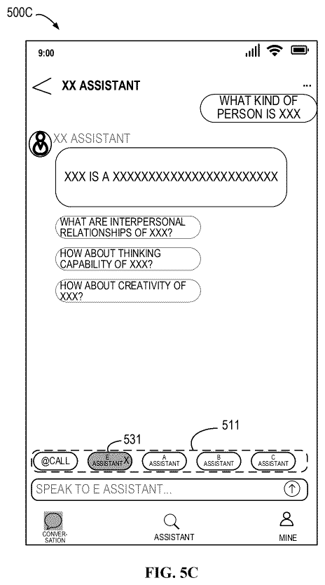

Receiving the selection of one or more digital assistants by the user based on the triggering of the addition entry will continue to be described below with reference to FIG. 5A to FIG. 5C. FIG. 5A to FIG. 5C illustrate schematic diagrams of example interfaces 500A-500C for adding digital assistants, in accordance with some embodiments of the present disclosure.

In some embodiments, the terminal device 110 presents an addition entry for adding the digital assistant in the interface of the target session. In some embodiments, an addition entry (also sometimes referred to as a “call entry”) is used to pull the digital assistant for the reply message into the target session. It may be understood that the currently added digital assistant does not belong to a member of the target session. As shown in the example interface 500A shown in FIG. 5A, the terminal device 110 may present the addition entry 512 at the interface of the target session.

In some embodiments, if a trigger operation for addition entry is detected, the terminal device 110 presents assistant information related to the at least one candidate digital assistant. As shown in the example interface 500B of FIG. 5B, if the user 140 clicks on the addition entry 512, the terminal device 110 presents a floating layer 521 that includes assistant information related to the at least one candidate digital assistant. In some embodiments, the floating layer 521 further includes a search box 522, which the user 140 may search for a digital assistant required based on the search box 522.

In some embodiments, the terminal device 110 may determine the candidate digital assistants based on one or more interaction messages in the target session and/or a digital assistant selected by the user in the target session. In some examples, the terminal device 110 may recommend the candidate digital assistant to the user 140 according to the content of the user 140 interacting with the digital assistant in the target session. For example, the configuration information of the recommended candidate digital assistant matches the subject matter of the interactive content. Alternatively or additionally, if the previous user has selected the digital assistant to temporarily engage in the session, the digital assistant may be further recommended according to the user's previous selections.

In some embodiments, when receiving the digital assistant addition operation for the target session, the terminal device 110 may present an interaction window of the target session in the first interface region. The terminal device 110 may also present assistant information of a plurality of candidate digital assistants in another interface region that is at least partially different from the first interface region. In some examples, if a digital assistant addition indication is detected (e.g., the control adding the digital assistant is triggered), the terminal device 110 may display the interaction window of the target session and the assistant recommendation page (which may include assistant information of a plurality of candidate digital assistants) in a split screen. For example, depending on the screen size and/or orientation of the terminal device 110, the interaction window and the assistant recommendation page may be presented on the upper half and the lower half of the user interface, respectively, or may be respectively presented on the left half and the right half of the user interface.

In some embodiments, the terminal device 110 may further present a search entry in the second interface region for searching the digital assistant from the plurality of candidate digital assistants. That is, a search entry for the digital assistant may be included in the assistant recommendation page. Thus, the user 140 may search the digital assistant for adding to the target session through the search entry.

In some embodiments, the assistant information of the plurality of candidate digital assistants is presented in the second interface region according to the grouping of the plurality of candidate digital assistants. The terminal device 110 may further group the plurality of candidate digital assistants, and then present, in the second interface region, assistant information respectively corresponding to each group of grouped digital assistants. As one example, standards for grouping may include whether the configuration information of the digital assistant is similar, e.g., the digital assistant in the same group has similar functionality. As another example, standards for grouping may include whether the functionality of the digital assistant is associated with the same topic, e.g., the digital assistants in the same group are all associated with travel. Therefore, the terminal device 110 displays the plurality of candidate digital assistant clusters.

The terminal device 110 then receives a selection of a candidate digital assistant in the at least one candidate digital assistant to determine the selected candidate digital assistant as at least a portion of the one or more target digital assistants. The user 140 selects one or more candidate digital assistants from the at least one candidate digital assistant to pull the selected one or more candidate digital assistants into the target session. As shown in the example interfaces 500B-500C shown in FIG. 5B to FIG. 5C, the user 140 may select the E assistant from the A assistant, the B assistant, the C assistant, the D assistant, the E assistant, etc., to pull the E assistant into the target session for replying to the first message.

In some embodiments, the identification information of the selected candidate digital assistant is presented in a preset interface region of the target session to indicate that the selected candidate digital assistant joins the target session. In some examples, if the identification information of the candidate digital assistant selected by the user 140 from the at least one candidate digital assistant has been presented in the preset interface region (sometimes referred to as the “operation bar”), the terminal device 110 sets the candidate digital assistant to be in the selected state. If the identification information of the candidate digital assistant selected by the user 140 from the at least one candidate digital assistant is not presented in the preset interface area, the terminal device 110 presents the identification information of the candidate digital assistant in the preset interface area.

In some other embodiments, if the identification information of the digital assistant included in the preset interface region reaches the preset capacity, the terminal device 110 removes the presented identification information of the at least one digital assistant from the preset interface region. Then, the terminal device 110 adds the identification information of the selected candidate digital assistant to the preset interface region.

In some examples, if the identification information of the candidate digital assistant selected by the user 140 from the at least one candidate digital assistant is not presented in the preset interface region, and the capacity of the preset interface region is full, the terminal device 110 removes identification information of the at least one presented digital assistant from the preset interface region. Subsequently, the terminal device 110 presents the identification information of the candidate digital assistant in the preset interface region. As shown in the example interfaces 500A to 500C shown in FIG. 5A to FIG. 5C, when the preset capacity of the operation bar 511 includes the identification information of the call entry, the identification information of the A assistant, the identification information of the B assistant, the identification information of the C assistant, and the identification information of the D assistant, if the user 140 selects the E assistant from the at least one candidate digital assistant, the terminal device 110 removes the identification information of the D assistant, and then adds the identification information 531 of the E assistant to the operation bar 511.

In some embodiments, the currently added digital assistant may be presented at the head of the operation bar and in the selected state. In some examples, if the selected state of the currently added digital assistant is cancelled, the identification information of the currently added digital assistant is still presented in the operation bar.

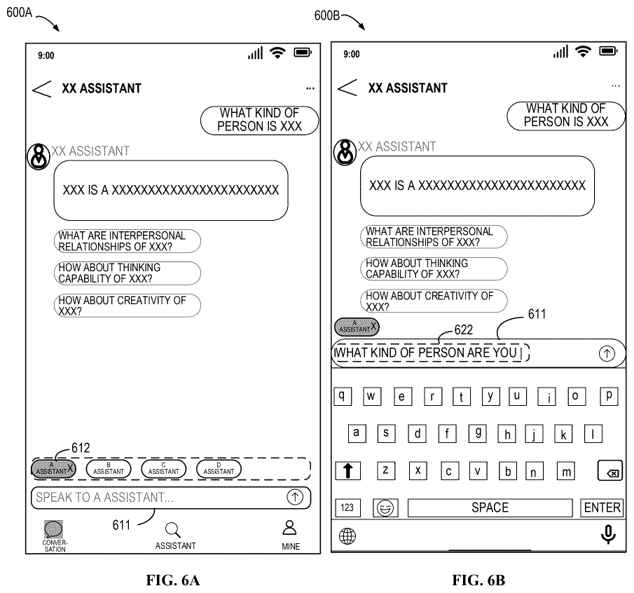

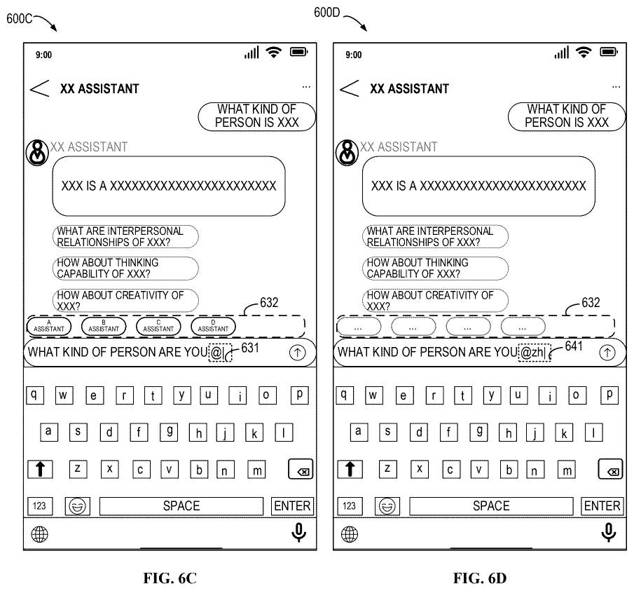

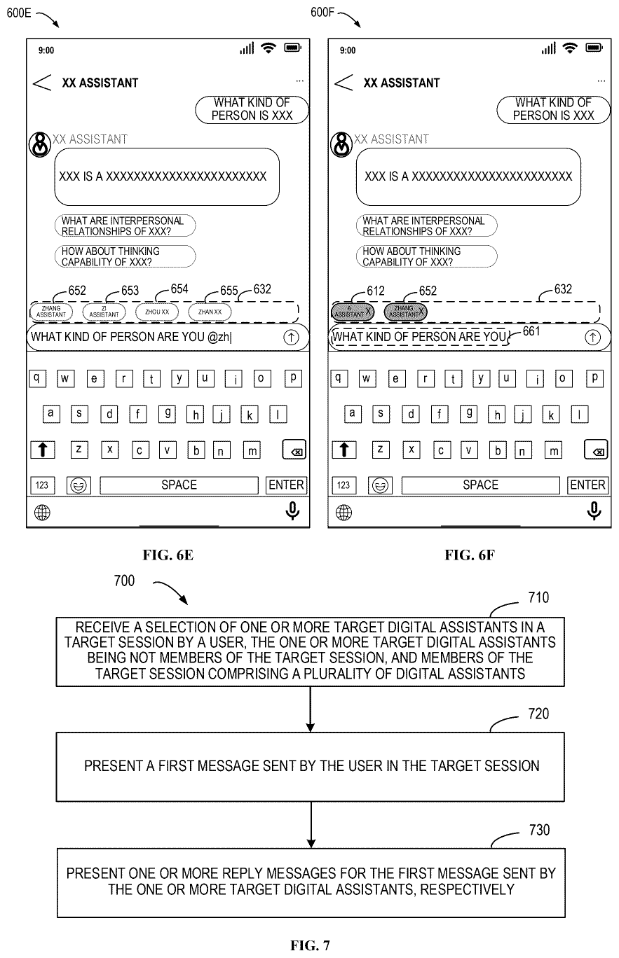

The selection of the one or more target digital assistants in the target session by the user is received when the user input mention information (e.g., “@”) will continue to be described below with reference to FIG. 6A to FIG. 6F. FIG. 6A to FIG. 6F illustrate schematic diagrams of example interfaces 600A-600F for session interaction, in accordance with some embodiments of the present disclosure.

In some embodiments, the target session includes an input box. As shown in the example interface 600A of FIG. 6A, the target session includes an input box 611. If detecting the user input in the input box, the terminal device 110 presents at least one matching digital assistant matching the user input, where the user input includes mention information. In some examples, in a scenario in which the user has selected and/or has not select one or more target digital assistants, the terminal device 110 presents at least one matching digital assistant matching the user input if the user input mention information in the input box is detected.

As shown in the example interfaces 600A-600E shown in FIGS. 6A to 6E, if it is detected that the user 140 clicks the input box 611, the keyboard is popped up for the user 140 to input a message. After the user 140 inputs the message 622, if the user 140 continues to input @, the terminal device 110 presents the selection box 632 in the interface of the target session. The selection box 632 presented by the terminal device 110 includes identification information of the target digital assistant for recommendation.

Subsequently, if the terminal device 110 detects that the user 140 continues to input @ zh, the terminal device 110 presents the selection box 632 in the loading state. The terminal device 110 presents, according to the input @ zh641 of the user 140, the identification information of zhang assistant, the identification information of zi assistant, zhou XX, zhanXX, and the like for recommending a matching the user input in the selection box 632.

In some embodiments, the terminal device 110 receives a selection of a matching digital assistant in the at least one matching digital assistant to determine the selected matching digital assistant as at least a part of the one or more target digital assistants. As shown in the example interfaces 600E to 600F shown in FIG. 6E to FIG. 6F, the user 140 may select “zhang assistant” from the identification information of zhang assistant, the identification information of zi assistant, zhou XX, zhan XX, and the like recommended by the terminal device 110. The terminal device 110 determines the “zhang assistant” as part of the one or more target digital assistants based on the selection of the user 140.

Correspondingly, when the user 140 clicks the selection control 652 of the target digital assistant selected by the user 140, the message “@ XXX” input by the user 140 disappears. As shown in the example interface 600F shown in FIG. 6F, when the user 140 clicks the selection control 652 of zhang assistant, the message 641 “@ zh” input by the user 140 disappears and becomes the message 661.

In some embodiments, when the terminal device 110 supports the user 140 to select one digital assistant, after receiving the target digital assistant selected by the user 140, the terminal device 110 replaces the target digital assistant selected by the terminal device 110 with the target digital assistant that has been in the selected state. When the terminal device 110 supports the user 140 to select one or more digital assistants, after receiving the target digital assistant selected by the user 140, the terminal device 110 determines the target digital assistant selected by the terminal device 110 as a part of the one or more target digital assistants.

In some embodiments, the terminal device 110 receives the second message sent by the user in the target session. If the one or more target digital assistants are in the selected state, the terminal device 110 presents one or more reply messages for the second message sent by the one or more target digital assistants, respectively. It may be understood that, when the user 140 does not cancel the selected state of the one or more target digital assistants and continues to send the second message, the terminal device 110 presents one or more reply messages for the second message that are respectively sent by the one or more target digital assistants.

In some embodiments, if detecting that the user cancels the selection of the one or more target digital assistants, the terminal device 110 receives the third message sent by the user in the target session. Correspondingly, the terminal device 110 presents one or more reply messages for the third message that are sent by the preset digital assistant in the target session. It may be understood that, after the user 140 cancels the selected state of the one or more target digital assistants and continues to send the third message, the terminal device 110 presents one or more reply messages for the third message that are sent by the preset digital assistant. In some embodiments, the preset digital assistant belongs to a member of the target session.

As shown in the example interfaces 200E to 200F shown in FIG. 2E to FIG. 2F, after the user 140 cancels the selected state of the A assistant and the B assistant, continues to input a message in the input box 261, and sends the message, the terminal device 110 presents a reply message for the message sent by the preset digital assistant. In some embodiments, the preset digital assistant belongs to a member of the target session. As shown in the example interfaces 300D to 300E shown in FIG. 3D to FIG. 3E, after the user 140 cancels the selected state of the A assistant, continues to input a message in the input box 316, and sends the message, the terminal device 110 presents a reply message for the message sent by the preset digital assistant. In some embodiments, the preset digital assistant belongs to a member of the target session.

In summary, the user may select a digital assistant that does not belong to the session to reply to the message sent by the user, thereby improving convenience of interaction between the user and the digital assistant.

### Example Processes

FIG. 7 shows a flowchart of a process 700 for session interaction according to some embodiments of the present disclosure. Process 700 may be implemented at terminal device 110. The process 700 is described below with reference to FIG. 1.

At block 710, the terminal device 110 receives a selection of one or more target digital assistants in a target session by a user, the one or more target digital assistants being not members of the target session, and members of the target session comprising a plurality of digital assistants.

In block 720, the terminal device 110 presents a first message sent by the user in the target session.

At block 730, the terminal device 110 presents one or more reply messages for the first message sent by the one or more target digital assistants, respectively.

In some embodiments, the process 700 further includes: in response to receiving a digital assistant addition operation for the target session, presenting an interaction window of the target session in a first interface region; and presenting assistant information of a plurality of candidate digital assistants in a second interface region, the second interface region being at least partially different from the first interface region.

In some embodiments, the second interface region comprises a search entry for searching a digital assistant from the plurality of candidate digital assistants.

In some embodiments, the assistant information of the plurality of candidate digital assistants is presented in the second interface region according to groupings of the plurality of candidate digital assistants.

In some embodiments, the process 700 further includes determining a plurality of candidate digital assistants based on at least one of: one or more interaction messages in the target session, or a digital assistant selected by the user in the target session; and presenting assistant information of the plurality of candidate digital assistants for selecting the one or more target digital assistants.

In some embodiments, receiving a selection of one or more target digital assistants in a target session by a user comprises: presenting a selection control for at least one digital assistant in an interface of the target session; and receiving a trigger operation for a respective selection control of the one or more target digital assistants of the at least one digital assistant.

In some embodiments, the process 700 further includes in response to the trigger operation, presenting the respective selection control of the one or more target digital assistants in a predetermined style.

In some embodiments, presenting the first message sent by the user in the target session comprises: receiving a user input for the one or more target digital assistants; and in response to a sending operation for the user input, presenting the user input and mention information of the one or more target digital assistants as the first message.

In some embodiments, the mention information is presented in the first message in a preset style, and the preset style is associated with the number of the one or more target digital assistants.

In some embodiments, presenting the first message sent by the user in the target session comprises: presenting the first message mentioning the one or more target digital assistants, respectively, in response to a selection of one or more target digital assistants of the at least one digital assistant, and the one or more first reply messages respectively comprise respective introduction information for the one or more target digital assistants.

In some embodiments, receiving a selection of one or more target digital assistants in a target session by a user comprises: presenting an addition entry for adding a digital assistant in an interface of the target session; presenting assistant information related to at least one candidate digital assistant in response to a trigger operation on the addition entry; and receiving a selection of a candidate digital assistant of the at least one candidate digital assistant, to determine the selected candidate digital assistant as at least a portion of the one or more target digital assistants.

In some embodiments, identification information of the selected candidate digital assistant is presented in a preset interface region of the target session, to indicate the selected candidate digital assistant to join the target session.

In some embodiments, the process 700 further includes: in response to identification information of digital assistants included in the preset interface region reaching a preset capacity, removing identification information of at least one presented digital assistant from the preset interface region; and adding identification information of the selected candidate digital assistant to the preset interface region.

In some embodiments, the target session comprises an input box, and receiving a selection of one or more target digital assistants in a target session by a user comprises: in response to detecting a user input in the input box, presenting at least one matching digital assistant that matches the user input, the user input comprising mention information; and receiving a selection of a matching digital assistant of the at least one matching digital assistant, to determine the selected matching digital assistant as at least a portion of the one or more target digital assistants.

In some embodiments, process 700 further includes receiving a second message sent by the user in the target session; and in response to the one or more target digital assistants being in a selected state, presenting one or more reply messages for the second message sent by the one or more target digital assistants, respectively.

In some embodiments, the process 700 further includes: in response to canceling the selection of the one or more target digital assistants, receiving a third message sent by the user in the target session; and presenting one or more reply messages for the third message sent by a preset digital assistant in the target session.

### Example Apparatus and Apparatus

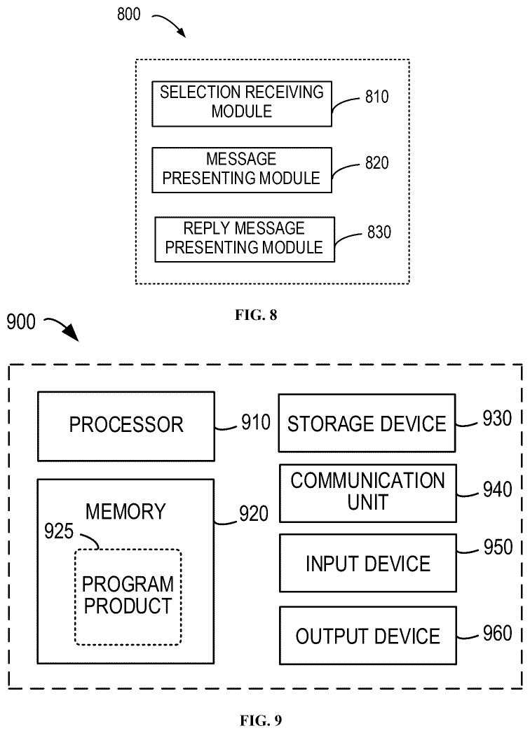

FIG. 8 is a schematic structural block diagram of an apparatus 800 for session interaction according to some embodiments of the present disclosure. The apparatus 800 may be implemented or included in the terminal device 110. The various modules/components in the apparatus 800 may be implemented by hardware, software, firmware, or any combination thereof.

As shown, the apparatus 800 includes a selection receiving module 810 configured to receive a selection of one or more target digital assistants by a user in a target session, the one or more target digital assistants being not members of the target session, and members of the target session comprise a plurality of digital assistants. The apparatus 800 further includes a message presentation module 820 configured to present a first message sent by the user in the target session. The apparatus 800 further includes a reply message presenting module 830 configured to present one or more reply messages for the first message sent by the one or more target digital assistants, respectively.

In some embodiments, the apparatus 800 further includes an interface region presentation module configured to present, in response to receiving the digital assistant addition operation for the target session, an interaction window of the target session in a first interface region; and presenting assistant information of a plurality of candidate digital assistants in a second interface region, the second interface region being at least partially different from the first interface region.

In some embodiments, the second interface region comprises a search entry for searching a digital assistant from the plurality of candidate digital assistants.

In some embodiments, the assistant information of the plurality of candidate digital assistants is presented in the second interface region according to groupings of the plurality of candidate digital assistants.

In some embodiments, the apparatus 800 further includes determining a plurality of candidate digital assistants based on at least one of: one or more interaction messages in the target session, or a digital assistant selected by the user in the target session; and presenting assistant information of the plurality of candidate digital assistants for selecting the one or more target digital assistants.

In some embodiments, the selection receiving module 810 is further configured to present a selection control for at least one digital assistant in an interface of the target session; and receive a trigger operation for a respective selection control of the one or more target digital assistants of the at least one digital assistant.

In some embodiments, the apparatus 800 further includes a control presentation module configured to present, in response to the trigger operation, the respective selection control of the one or more target digital assistants in a predetermined style.

In some embodiments, the message presentation module 820 is further configured to receive a user input for the one or more target digital assistants; and in response to a sending operation for the user input, present the user input and mention information of the one or more target digital assistants as the first message.

In some embodiments, mention information is presented in a first message in a preset style, and the preset style is associated with the number of the one or more target digital assistants.

In some embodiments, the message presentation module 820 is further configured to present, in response to selection of one or more target digital assistants of the at least one digital assistant, the first message mentioning the one or more target digital assistants, respectively, and the one or more first reply messages respectively comprise respective introduction information for the one or more target digital assistants.

In some embodiments, the selection receiving module 810 is further configured to present, in an interface of the target session, an add entry for adding the digital assistant; in response to a trigger operation on the addition entry, present assistant information related to at least one candidate digital assistant; and receive a selection of a candidate digital assistant of the at least one candidate digital assistant, to determine the selected candidate digital assistant as at least a portion of the one or more target digital assistants.

In some embodiments, the identification information of the selected candidate digital assistant is presented in a preset interface region of the target session, to indicate the selected candidate digital assistant to join the target session.

In some embodiments, the apparatus 800 further includes an identification information adding module configured to, in response to the identification information of the digital assistant included in the preset interface region reaching a preset capacity, remove identification information of at least one presented digital assistant from the preset interface region; and add identification information of the selected candidate digital assistant to the preset interface region.

In some embodiments, the target session includes an input box, and the selection receiving module 810 is further configured to, in response to detecting the user input in the input box, present at least one matching digital assistant that matches the user input, the user input comprising mention information; and receive a selection of a matching digital assistant of the at least one matching digital assistant, to determine the selected matching digital assistant as at least a portion of the one or more target digital assistants.

In some embodiments, the reply message presenting module 830 is further configured to receive a second message sent by the user in the target session; and in response to the one or more target digital assistants being in a selected state, present one or more reply messages for the second message sent by the one or more target digital assistants, respectively.

In some embodiments, the reply message presenting module 830 is further configured to, in response to canceling the selection of the one or more target digital assistants, receive a third message sent by the user in the target session; and present one or more reply messages for the third message sent by a preset digital assistant in the target session.

FIG. 9 illustrates a block diagram of an electronic device 900 in which one or more embodiments of the present disclosure can be implemented. It should be understood that the electronic device 900 illustrated in FIG. 9 is merely exemplary and should not constitute any limitation on the functionality and scope of the embodiments described herein. The electronic device 900 shown in FIG. 9 may be configured to implement the terminal device 110 and the server 130 in FIG. 1.

As shown in FIG. 9, the electronic device 900 is in the form of a general-purpose electronic device. Components of the electronic device 900 may include, but are not limited to, one or more processors or processing unit 910, a memory 920, a storage device 930, one or more communication units 940, one or more input devices 950, and one or more output devices 960. The processing unit 910 may be an actual or virtual processor and capable of performing various processes according to programs stored in the memory 920. In multiprocessor systems, multiple processors execute computer-executable instructions in parallel to improve parallel processing capabilities of electronic device 900.

Electronic device 900 typically includes a plurality of computer storage medium. Such media may be any available media accessible to the electronic device 900, including, but not limited to, volatile and non-volatile media, removable and non-removable media. The memory 920 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 930 may be a removable or non-removable medium and may include a machine-readable medium, such as a flash drive, magnetic disk, or any other medium, which may be capable of storing information and/or data and may be accessed within electronic device 900.

The electronic device 900 may further include additional removable/non-removable, volatile/non-volatile storage medium. Although not shown in FIG. 9, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 920 may include a computer program product 925 having one or more program modules configured to perform various methods or actions of various embodiments of the present disclosure.

The communication unit 940 is configured to communicate with another electronic device through a communication medium. Additionally, the functionality of components of the electronic device 900 may be implemented in a single computing cluster or multiple computing machines, these computing machines are capable of communicating over a communication connection. Thus, the electronic device 900 may operate in a networked environment using logical connections with one or more other servers, network personal computers (PCs), or another network node.

The input device 950 may be one or more input devices such as a mouse, a keyboard, a trackball, or the like. The output device 960 may be one or more output devices, such as a display, a speaker, a printer, or the like. The electronic device 900 may also communicate with one or more external devices (not shown) through the communication unit 940 as needed, external devices such as storage devices, display devices, etc., communicate with one or more devices that enable a user to interact with the electronic device 900, or communicate with any device (e.g., a network card, a modem, etc.) that enables the electronic device 900 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable storage medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in one or more blocks in the flowchart and/or block diagram. These computer-readable program instructions may also be stored in a computer-readable medium that cause the computer, programmable data processing apparatus, and/or other devices to function in a particular manner, such that the computer-readable storage medium storing instructions includes an article of manufacture including instructions to implement aspects of the functions/acts specified in one or more blocks in the flowchart and/or block diagram.

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/acts specified in one or more blocks in the flowchart and/or block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method of session interaction, comprising:
receiving a selection of one or more target digital assistants in a target session by a user, the one or more target digital assistants being not members of the target session, and members of the target session comprising a plurality of digital assistants;
presenting a first message sent by the user in the target session; and
presenting one or more reply messages for the first message sent by the one or more target digital assistants, respectively.

2. The method of claim 1, further comprising:
in response to receiving a digital assistant addition operation for the target session,
presenting an interaction window of the target session in a first interface region; and
presenting assistant information of a plurality of candidate digital assistants in a second interface region, the second interface region being at least partially different from the first interface region.

3. The method of claim 2, wherein the second interface region comprises a search entry for searching a digital assistant from the plurality of candidate digital assistants.

4. The method of claim 2, wherein assistant information of the plurality of candidate digital assistants is presented in the second interface region according to groupings of the plurality of candidate digital assistants.

5. The method of claim 1, further comprising:
determining a plurality of candidate digital assistants based on at least one of:
one or more interaction messages in the target session, or
a digital assistant selected by the user in the target session; and
presenting assistant information of the plurality of candidate digital assistants for selecting the one or more target digital assistants.

6. The method of claim 1, wherein receiving a selection of one or more target digital assistants in a target session by a user comprises:
presenting a selection control for at least one digital assistant in an interface of the target session; and
receiving a trigger operation for a respective selection control of the one or more target digital assistants of the at least one digital assistant.

7. The method of claim 6, further comprising:
in response to the trigger operation, presenting the respective selection control of the one or more target digital assistants in a predetermined style.

8. The method of claim 6, wherein presenting the first message sent by the user in the target session comprises:
receiving a user input for the one or more target digital assistants; and
in response to a sending operation for the user input, presenting the user input and mention information of the one or more target digital assistants as the first message.

9. The method of claim 8, wherein the mention information is presented in the first message in a preset style, and the preset style is associated with the number of the one or more target digital assistants.

10. The method of claim 6, wherein presenting the first message sent by the user in the target session comprises:
presenting the first message mentioning the one or more target digital assistants, respectively, in response to a selection of one or more target digital assistants of the at least one digital assistant, and
the one or more first reply messages respectively comprise respective introduction information for the one or more target digital assistants.

11. The method of claim 1, wherein receiving a selection of one or more target digital assistants in a target session by a user comprises:
presenting an addition entry for adding a digital assistant in an interface of the target session;
presenting assistant information related to at least one candidate digital assistant in response to a trigger operation on the addition entry; and
receiving a selection of a candidate digital assistant of the at least one candidate digital assistant, to determine the selected candidate digital assistant as at least a portion of the one or more target digital assistants.

12. The method of claim 11, wherein identification information of the selected candidate digital assistant is presented in a preset interface region of the target session, to indicate the selected candidate digital assistant to join the target session.

13. The method of claim 11, further comprising:
in response to identification information of digital assistants included in the preset interface region reaching a preset capacity, removing identification information of at least one presented digital assistant from the preset interface region; and
adding identification information of the selected candidate digital assistant to the preset interface region.

14. The method of claim 1, wherein the target session comprises an input box, and receiving a selection of one or more target digital assistants in a target session by a user comprises:
in response to detecting a user input in the input box, presenting at least one matching digital assistant that matches the user input, the user input comprising mention information; and
receiving a selection of a matching digital assistant of the at least one matching digital assistant, to determine the selected matching digital assistant as at least a portion of the one or more target digital assistants.

15. The method of claim 1, further comprising:
receiving a second message sent by the user in the target session; and
in response to the one or more target digital assistants being in a selected state, presenting one or more reply messages for the second message sent by the one or more target digital assistants, respectively.

16. The method of claim 1, further comprising:
in response to canceling the selection of the one or more target digital assistants, receiving a third message sent by the user in the target session; and
presenting one or more reply messages for the third message sent by a preset digital assistant in the target session.

17. (canceled)

18. An electronic device, comprising:
at least one processor and
at least one memory, the at least one memory coupled to the at least one processor and storing instructions for execution by the at least one processor the instructions upon execution by the at least one processor unit, causing the electronic device to perform operations comprising:
receiving a selection of one or more target digital assistants in a target session by a user, the one or more target digital assistants being not members of the target session, and members of the target session comprising a plurality of digital assistants;
presenting a first message sent by the user in the target session; and
presenting one or more reply messages for the first message sent by the one or more target digital assistants, respectively.

19. (canceled)

20. The device of claim 18, wherein the operations further comprise:
in response to receiving a digital assistant addition operation for the target session,
presenting an interaction window of the target session in a first interface region; and
presenting assistant information of a plurality of candidate digital assistants in a second interface region, the second interface region being at least partially different from the first interface region.

21. The device of claim 20, wherein the second interface region comprises a search entry for searching a digital assistant from the plurality of candidate digital assistants.

22. A non-transitory computer-readable storage medium having a computer program stored thereon, the computer program, when executed by a processor, causing the processor to perform operations comprising:
receiving a selection of one or more target digital assistants in a target session by a user, the one or more target digital assistants being not members of the target session, and members of the target session comprising a plurality of digital assistants;
presenting a first message sent by the user in the target session; and
presenting one or more reply messages for the first message sent by the one or more target digital assistants, respectively.
